(19) United States
(12) Patent Application Publication
(10) Pub. No.: US 2026/0067719 A1
(43) Pub. Date: Mar. 5, 2026

(54) Minimization of Service Interruptions of Core Network Failure

(71) Applicant: Apple Inc., Cupertino, CA (US)

(72) Inventors: Behrouz Aghili, Poway, CA (US); Yuqin Chen, Beijing (CN); Sudeep Manithara Vamanan, Uttenreuth (DE); Haijing Hu, Los Gatos, CA (US); Mona Agnel, Guildford (GB)

(73) Assignee: Apple Inc., Cupertino, CA (US)

(21) Appl. No.: 19/106,389

(22) PCT Filed: Sep. 22, 2022
(86) PCT No.: PCT/CN2022/120649

§ 371 Date: Feb. 25, 2025

(51) Int. Cl. H04W 24/04; H04W 4/06; H04W 4/90; H04W 68/02

(52) U.S. Cl. CPC H04W 24/04; H04W 4/06; H04W 4/90; H04W 68/02

(57) ABSTRACT

Techniques are disclosed for the minimization of service interruptions for core network failure. One example includes a method in which a disaster control function (DCF) receives, from an access and mobility function (AMF), an address of a base station managed by the AMF. The DCF detects an interruption of services provided by the AMF. The DCF transmits, to the base station and using the address, a message indicting the interruption of services provided by the AMF.

### BACKGROUND

Cellular communications can be defined in various standards to enable communications between a user equipment and a cellular network. For example, the Fifth generation (5G) mobile network is a wireless standard that aims to improve upon data transmission speed, reliability, availability, and more.

### BRIEF DESCRIPTION OF THE DRAWINGS

FIG. 1 illustrates a system for minimization of interruptions of core network failure, according to one or more embodiments.

FIG. 2 is a signaling diagram for minimization of interruptions of core network failure, according to one or more embodiments.

FIG. 3 is a signaling diagram for minimization of interruptions of core network failure, according to one or more embodiments.

FIG. 4 is a signaling diagram for minimization of interruptions of core network failure, according to one or more embodiments.

FIG. 5 is a process flow for minimization of interruptions of core network failure, according to one or more embodiments.

FIG. 6 is a process flow for minimization of interruptions of core network failure, according to one or more embodiments.

FIG. 7 is a process flow for minimization of interruptions of core network failure, according to one or more embodiments.

FIG. 8 illustrates an example of receive components, according to one or more embodiments.

FIG. 9 illustrates an example of a user equipment (UE), according to one or more embodiments

FIG. 10 illustrates an example of a base station, according to one or more embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

An access and mobility function (AMF) is a control plane network function of a core network (CN). Some of the main functionalities include registration management, reachability management, connection management, and mobility management. Registration management includes allowing a user equipment (UE) to register or de-register with a network. Connection management includes establishing and releasing control plane signaling connections between the AMF and the UE. Reachability management includes ensuring that the UE is reachable. Mobility management includes maintaining a location of the UE within the network.

Each operator, (e.g., Verizon, Sprint T-Mobile, AT & T) controls their own CN, that each include multiple AMF instances. Each AMF instance controls a set of base stations that each provide cellular coverage for the operator's customers. The cellular coverage can be logically described as tracking area (TAs), where each TA is a set of cells. One or more TAs can logically be described as a registration area (RA), where the one or more TAs can be described as a list of TAs. A UE can move freely about a RA without having to re-register through the base station. In the event that an AMF experiences a failure, there can be a service interruption for any UE camped in a cell controlled by the AMF via a base station.

In 3GPP release 19, a new CN node, the disaster control function (DCF), which is to have a direct interface with the CNs AMFs, is to be introduced. The DCF is to have the functionality of receiving “alarms” from the AMF(s) in case the AMF experiences a service interruption. The DCF can be located in a secure area away from the AMFs. For example, if a natural disaster damages an AMF's hardware to the point that the AMF can no longer function, the DCF can be secure at a remote location to keep functioning. In the absence of the AMF, the DCF can function to reintroduce service to a UE affected by the service interruption at the AMF.

Embodiments of the present disclosure are described in connection with 5G networks. However, the embodiments are not limited as such and similarly apply to other types of communication networks, including other types of cellular networks, such as an LTE network.

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device, including a wireless communications interface.

The term “base station” as used herein refers to a device with radio communication capabilities, which is a network component of a communications network (or, more briefly, a network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “network” as used herein reference to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “3GPP Access” refers to accesses (e.g., radio access technologies) that are specified by 3GPP standards. These accesses include, but are not limited to, GSM/GPRS, LTE, LTE-A, or 5G NR. In general, 3GPP access refers to various types of cellular access technologies.

The term “Non-3GPP Access” refers any accesses (e.g., radio access technologies) that are not specified by 3GPP standards. These accesses include, but are not limited to, WiMAX, CDMA2000, Wi-Fi, WLAN, or fixed networks. Non-3GPP accesses may be split into two categories, “trusted” and “untrusted”: Trusted non-3GPP accesses can interact directly with an evolved packet core (EPC) or a 5G core (5GC), whereas untrusted non-3GPP accesses interwork with the EPC/5GC via a network entity, such as an Evolved Packet Data Gateway or a 5G NR gateway. In general, non-3GPP access refers to various types on non-cellular access technologies.

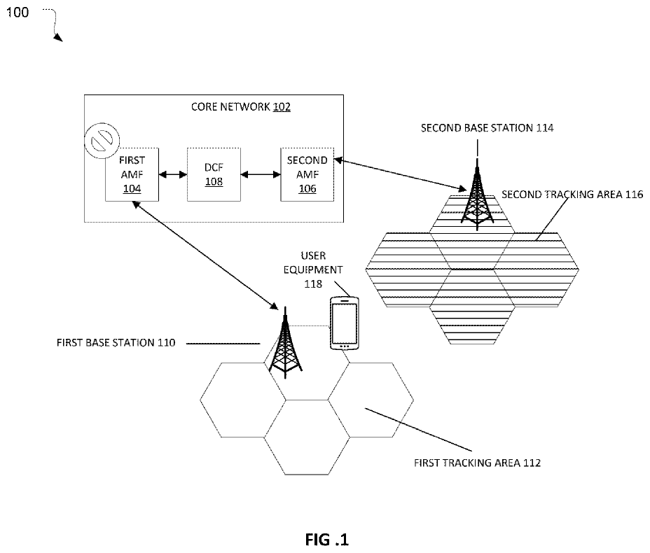

FIG. 1 illustrates a system for minimization of interruptions of core network failure, according to one or more embodiments. A CN 102 can include a first AMF 104 (e.g., first AMF instance) and a second AMF 106 (e.g., second AMF instance), which are each in communication with a DCF 108. The first AMF 104 can control a first base station 110 that provides service for a cell included in a first tracking area 112. The second AMF 106 can control a second base station 114 that provides service to a cell of a second tracking area 116.

It should be appreciated that the although the embodiments described herein describe a 5G CN, the CN 102 can be a sixth generation (6G) CN in that a 6G CN architecture is comparable with a 5G CN architecture. The CN 102 can include the first AMF 104, the second AMF 106, and the DCF 108, which are each in communication using an underlay network. The CN can be controlled by an operator (e.g., Verizon, AT & T), that provides cellular services to its customers.

The first base station 110 and the second base station 114 can be in communication with the CN 102. The first base station 110 and the second base station 114 can be any type of base station, such as the cell towers illustrated in FIG. 1.

The first base station 110 and the second base station 112 can respectively communicate with the first AMF 104 and the second AMF 106 via their NG interface (NG). The NGs can respectively connect each base station to the CN 102. A control plane of an NG can permit signaling between a base station and an AMF. The user plane of the NG can permit the transfer of application data between a base station and an AMF 104. In embodiments described herein, an NG can be configured to transmit and receive messages between a base station and the AMF 104.

Each of the first AMF 104 and the second AMF 106 can communicate with DCF 108 using the underlay network. In some embodiments, the underlay network provides a direct interface between the DCF 108 and the AMF instances. The direct interface can be a service-based interface for the first AMF 104. The direct interface can be configured to transmit alarm messages and heartbeat requests/heartbeat request responses to and from the first AMF 104 and the second AMF 106 to the DCF 108. Based on the above, the importance of the first AMF 104 can be seen for communicating data between the CN 102 and the rest of the network.

The concept of minimization of service interruptions (MINT) was introduced in 3GPP as a new work item in Release 17. At that time, the work item description (WID) for MINT was based on the scenarios where an operator's Radio Access Network (RAN), or a portion of it, would be non-functional due to, for example, a disaster in a geographical area of the network. A driver behind the MINT work item was an incident in South Korea where the SK Telecom's network experienced a major impact and became almost totally unreachable due to a fire disaster in Seoul. Referring back to FIG. 1, at some point in time, the first AMF 104 can experience an interruption of service (e.g., an AMF failure as a result of a natural disaster). As a result, the first base station 110 may be unable to provide cellular service. A UE 116 camped in the same cell as the first base station 110 may experience an interruption of the service as a result of the failure of the first AMF 104. In response, conventional networks are configured to shift affected customers to another operator's network. For example, if an AMF at a CN managed by Verizon failed, the Verizon network would attempt to move customers to a network managed by another operator (e.g., T-Mobile). However, an unexpected influx of customers into a network can overload the network's capacity to provide good service to its own customers.

Embodiments herein address the above-referenced issues using a base station that can communicate with a DCF and an AMF. In the instance the AFM experiences an interruption of service, the DCF can notify a base station controlled by the AMF. The AMF can assist a UE find another AMF controlled by the same operator as the AMF whose service has been interrupted.

Prior to any interruption of service, the first AMF 104 and the second AMF 106 can inform the DCF 108 of the addresses of all base stations that an AMF controls. In the event of an interruption of service, the affected AMF can send an indication to the DCF 108 of the interruption. As illustrated in FIG. 1, the first AMF 104 has experienced an interruption of service as noted by the “no” symbol. The first AMF 104 can transmit an indication to the DCF 108 that its services have been interrupted. The indication can be in the form of an alarm message or an absence of a heartbeat signal. For example, the first AMF can be configured to transmit a periodic signal (such as a “Heartbeat”) to the DCF 108. The absence of the heartbeat can be an indication that the first AMF 104 has experienced an interruption of service. The DCF 108 can then retrieve the address of all the base stations controlled by the first AMF 104. The DCF 108 can then inform all of these base stations (including the first base station 110) of the service interruption.

In response to receiving the information from the DCF 108, the first base station 110 can assist the UE 118 to reregister with the CN 102 through another AMF. The first base station 110 can determine if the UE 118 is in a connected mode or in idle mode. The UE 118 can be in a connected mode when, for example, there is an active radio resource control (RRC) connection, and the UE 118 is transmitting and receiving with a base station. The UE 118 can be in an idle mode when the UE 118 is turned on, but there is no RRC connection, and the UE 118 is not transmitting and receiving.

If the first base station 110 determines that the UE 118 is in a connected mode, the first base station 110 can inform the UE 118 of the service interruption using a dedicated signal. For instance, the first base station 110 can transmit an RRC release message with a certain cause code. In other instances, the first base station 110 can transmit an RRC release message with a new information element (IE) that points to the first AMF's interruption of service.

In addition to the above-referenced information, the first base station 110 can transmit additional information in the dedicated signaling. For example, the first base station 110 can transmit whether another AMF (e.g., the second AMF 106) in the public land mobile network (PLMN) is available or should the UE 118 directly attempt a minimization of service interruptions for core network (MINT) registration with another operator. The first base station 110 can also transmit a list of TAs to be excluded in a search for a new RA with which to register. The TAs can include TAs that were controlled by the first AMF 104.

In the event that the AMF has experienced an interruption of service, the first base station 110 can cease to broadcast a system information block type (SIB1) and/or synchronization signal block (SSB). This occurs in instances that the first AMF 104 is the only AMF with which the first base station is able to connect. The UE 118 can be configured to receive and decode an SIB1 and SSB. However, in the event of an interruption of service at the first AMF 104, the first base station 110 can cease to transmit the SIB1 and SSB. The UE 118 can further be configured to detect that it did not receive the SIB1 and SSB and interpret this as the first AMF 104 has experienced an interruption of service.

In other instances, the first base station 110 can use a short message to inform the UE 118 that the first AMF 110 has experienced an interruption of service. For example, the first base station 110 can transmit the short message in downlink control information (DCI). A short message can be transmitted on a physical downlink control channel (PDCCH) using paging radio network temporary identifier (P-RNTI) without or without an associated paging message.

In other instances, the first base station 110 can use a special type of ‘paging” message to inform the UE that the first AMF 104 has experienced an interruption in service. The first base station 110 can use a paging protocol to transmit a paging message that informs the UE 118 that the first AMF 104 has experienced an interruption in service. For example, the first base station 110 can invoke a “global paging” to send message to all affecting UES (including UE 118). The first base station 110 can further include a special identifier (ID) (instead of a 5G-temporary mobile subscriber identity (TMSI)) that informs the UE that the first AMF 104 has experienced an interruption in service. The first base station 110 can also transmit a paging record, where the paging record specifies which UE (e.g., UE 118) is being paged within an RRC paging message. The paging record can include a UE identifier and the core network domain. The UE 118 can be configured during a registration as to which of the above techniques can be used to inform the UE 118 that the first AMF 104 has experienced an interruption in service.

If the first base station 110 determines that the UE 118 is in idle mode, the first base station 110 can use the following methods to inform the UE 118 that the first AMF 104 has experienced an interruption in service. In instances in which the radio access network (RAN) node is a shared one, the first base station 110 can stop broadcasting the PLMN-identifier (ID) of the PLMN. Additionally, the first base station 110 can include a bit in the SIB1 that indicates “disaster” or “the first AMF 104 down”.

In the event that the AMF has experienced an interruption of service, the first base station 110 can cease to broadcast a system information block type (SIB1) and/or synchronization signal block (SSB). This occurs in instances that the first AMF 104 is the only AMF with which the first base station is able to connect. The UE 118 can be configured to decode an SIB1 and SSB. However, in the event of an interruption of service at the first AMF, the first base station 110 can cease to transmit the SIB1 and SSB. The UE can further be configured to detect that it did not receive the SIB1 and SSB, and interpret this as the first AMF 104 has experienced an interruption of service.

Another method can be that the first base station 110 can broadcast a new SIB, wherein the new SIB can inform the UE 118 that the first AMF 104 has experienced an interruption in service.

In other instances, the first base station 110 can use a special type of ‘paging” message to inform the UE that the first AMF 104 has experienced an interruption in service. The first base station 110 can use a paging protocol to transmit a paging message that informs the UE 118 that the first AMF 104 has experienced an interruption in service. For example, the first base station 110 can invoke a “global paging” to send message to all affecting UES (including UE 118). The first base station 110 can further include a special identifier (ID) (instead of a 5G-temporary mobile subscriber identity (TMSI)) that informs the UE that the first AMF 104 has experienced an interruption in service. The first base station 110 can also transmit a paging record, where the paging record specifies which UE (e.g., UE 118) is being paged within an RRC paging message. The paging record can include a UE identifier and the core network domain. The UE 118 can be configured during a registration as to which of the above techniques can be used to inform the UE 118 that the first AMF 104 has experienced an interruption in service.

In relation to the global paging method, the UE 118 can report to the first base station 110 the capability to support this type of paging. For example, during an establishment of an RRC connection, the UE 118 can transmit a bit/parameter/IE, which indicates that the UE 118 supports this new method of global paging. This indication by the UE 118 can be performed using any of the following messages; RRC setup request, RRC setup complete, and UE capability information. In the event that the UE 118 does not indicate this capability to the first base station 110 during the transition from an idle mode to a connected mode, the first base station 110 can elect not to use the global paging method.

Another method to inform the UE that the first AMF 104 has experienced an interruption in service is to transmit a SysInfoModification indication, which is independent of any paging records. The UE 118 can read system information for cell camping when the UE 118 powered on, and for cell selection and re-selection when the UE 118 is in RRC idle mode. The system information can provide details such as a system frame number, a system bandwidth, applicable cell selection and re-selection thresholds, PLMN, and other information used to access the CN. During a modification period, the first base station 110 can transmit a message to inform the UE 118 that the first AMF 104 has experienced an interruption in service.

As an alternative, the UE 118 can transmit an RRC connection request, and the RAN can either reject the request or release the UE 118 from an RRC connection. To communicate the rejection, the first base station 110 can transmit a response including an RRC connection rejection or an RRC release to the UE 118. The first base station 110 can further include an indication that the CN is down.

The descriptions above relate to methods for informing the UE 118 that the first AMF 104 has experienced an interruption in service. Once the UE 118 is informed, a next step can be to keep the UE 118 in the original operator's network. As indicated above, in response to an interruption of service, networks are configured to shift affected customers to another operator's network. As described herein, the UE 118 can remain in the same operator's network by registering with another AMF (e.g., the second AMF 106).

Prior to the interruption of service, the first AMF 104 can transmit a list to the first base station 110, the list can include all the TAs for which the first AMF 106 is responsible. The second AMF 104 can transmit a list to the second base station 114, the list can include all the TAs for which the second AMF 106 is responsible.

In the event that the first AMF 104 experience an interruption of services, the first base station 110 can retrieve the list of the TAs for which the first AMF 106 is responsible. The first base station 110 can inform the UE 118 to reregister, but not try to register in those listed TAs, even though they are under the same current R-PLMN. As the first AMF 104 is experiencing an interruption of services, all of the TAs in the list will be unavailable.

In some instances, the UE 118 does detect an acceptable/suitable cell and determines that the tracking area ID (TAI) of the cell indicates that the cell is not part of the list (e.g., cell of the second TA 116, but within the same R-PLMN. In these instances, the UE 118 can ignore cell selection parameters (such as “hysteresis”) and camp on the detected cell. Cell selection parameters can include the strength of the signal transmitted from the second base station 114, acceptability of the PLMN, and other appropriate parameters that the UE 118 can use to determine whether to camp in a cell. This can be useful in instances in normal situation, in which a UE 118 is located between two cells and needs to determine within which to camp. However, in a situation such as a natural disaster, the UE 118 can be concerned with detecting any viable cell.

The UE can further apply an offset to the “wait range” in the event that the CN has previously sent offset to the UE 118, for example, using a registration accept or a configuration update command. As discussed above, current methods attempt to move a UE to a network of another operator in the event that a natural disaster damages the CN of the original operator. In order to prevent a flood of UEs registering with the other operator, a UE can be configured with an offset to stagger registrations with the other operator. This concept can be applied to instances in which the UE 118 is attempted to register on a new cell of the same operator. In the event that the first AMF 104 experiences an interruption of service, the offset can prevent a flood of UEs attempt to reregister on the same operator's network and overloading the network.

The UE 118 can perform registration in the same R-PLMN and transmit a registration request message to the second base station 114. The UE 118 can set the registration type set to mobility and periodic registration due to (previously registered) first AMF 104 experiences an interruption of service. Additionally, the registration request message can be sent with the UE identity set to subscription concealed identifier (SUCI), even though it has a valid 5G-global unique temporary identifier (GUTI) from the same PLMN. In combination, the registration type and the UE identity assist the second AMF 106 refrain from trying to contact the first AMF 104 in order to fetch context, and instead the second AMF 106 can go directly to the unified data management (UDM) to register the UE 118.

In some instances, the first base station 110 can have a connection with at least one more AMF than one being impacted by disaster. For example, the first station 110 has a connection with the first AMF 104 and the second AMF 106. Prior to the first AMF experiencing an interruption of services, the UE 118 can report to the first base station 110 that it can re-register in the event it receives a (newly) defined cause value or IE in an RRC connection release message. The first base station 110 can also indicate to the UE 118 that the paging method is supported in a registration accept message.

In these instances, the first base station 110 can detect that the first AMF 104 has experienced an interruption in service. For example, via a message from the DCF 108. In response, the first base station can determine whether the UE 118 is in a connected mode. If the UE 118 is in the connected mode, the first base station 110 can send a RRC release message to the UE 118 that includes the new cause value or IE. The UE 118 can receive the message and then transition to an idle mode and perform a new registration procedure associated with the second AMF 106. Additionally, the first base station 110 can route an initial non-access stratum (NAS) message from the UE 118 (e.g., the registration request) to the second AMF 106.

The first base station 110 can further detect other UEs in the cell that are in an idle mode. The first base station 110 can start broadcasting a special type of paging message to these other UEs. The paging message can be designed to either contain a special/global ID or a specific paging record. The first base station 110 can then start broadcasting this paging message continuously over a long period of time in order to make sure that all other UEs with different DRX cycles can receive this paging message.

Upon reception of this special paging message, the UEs can start a registration procedure associated with the second AMF 106. As indicated above, a sudden influx of registration requests can overload a system. Therefore, in order to stagger the registration attempts from all UEs in the cell, the first base station 110 can transmit an assigned (random) wait time to the UE in the registration accept message.

In other instances, the UE 118 can wait for a next procedure that is triggered by the NAS message (e.g., by the user request that would normally lead to sending a service request message) and then perform a registration procedure associated with the second AMF 106.

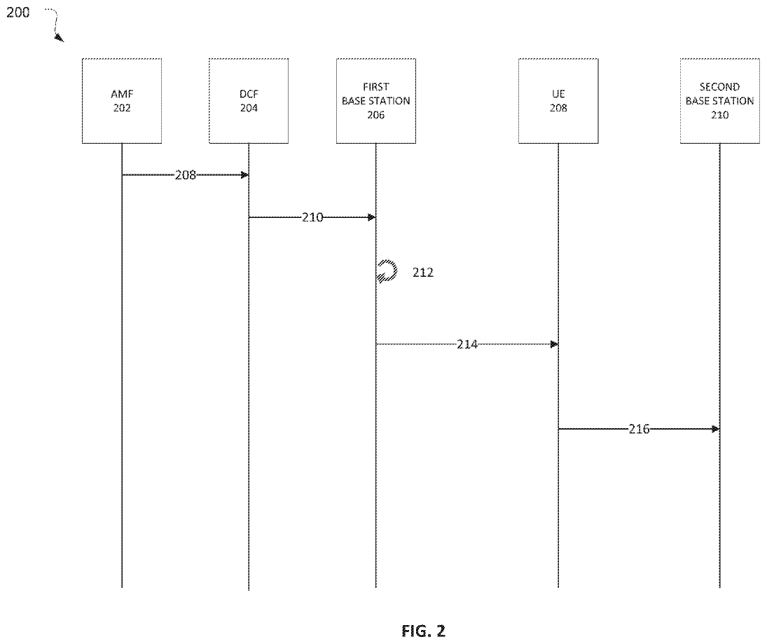

FIG. 2 is a signaling diagram for minimization of interruptions of core network failure, according to one or more embodiments. As illustrated, an AMF 202 can be in communication with a DCF 204, which can be in communication with a first base station 206. The first base station 206 can be in communication with a UE 208, which can initiate communication with a second base station 210.

At 208 an AMF can transmit an indication to the DCF 204 that it is experiencing an interruption of service. The indication can be in the form of an absence of a heartbeat response or an alarm message. Furthermore, both the AMF 202 and the DCF 204 can be part of a CN.

At 210, the DCF can transmit an indication to a first base station 206 that the AMF 202 is experiencing an interruption of service. The AMF 202 can be in control of the first base station 207 for an operator of the CN.

At 212, in response to the information that the AMF 202 is experiencing an interruption of service, the first base station can determine the UE that are receiving service from the first base station 206. For example, the first base station can determine which UEs are camped in a cell provided by the first base station 206. The first base station 206 can further determine which UEs are in an idle mode or in a connected mode.

At 214, the first base station 206 can notify the UE 208 that the AMF 202 is experiencing an interruption of service. The manner by which the first base station provides the notification is based on whether the UE 208 is in idle mode or connected mode. If the UE 208 is in connected mode, the notification can include dedicated signaling. For example, the first base station 206 can transmit an RRC release message with a certain cause code. In other instances, the first base station 206 can transmit an RRC release message with a new information element (IE) that points to the AMF's interruption of service.

The first base station 206 can additionally transmit whether another AMF in the PLMN is available or should the UE 118 directly attempt a MINT registration with another operator. The first base station 206 can also transmit a list of TAs to be excluded in a search for a new RA with which to register. The list of TAs can include TAs that provided service by base stations controlled by the AMF 202.

The first base station 206 can also cease to broadcast a system information block type SIB1 or SSB. This can occur in instances that the AMF 202 is the only AMF with which the first base station 206 is able to connect. The UE 208 can interpret the absence of the SIB1 or the SSB as the AMF 202 having experienced an interruption of service.

The first base station 206 can also use a short message to inform the UE 208 that the AMF 202 has experienced an interruption of service. For example, the first base station 206 can transmit the short message in DCI. In other instances, the first base station 206 can use a special type of ‘paging” message to inform the UE 208 that the first AMF 202 has experienced an interruption in service. For example, the first base station 206 can invoke a “global paging” to send message to all affecting UES (including UE 208). The first base station 206 can further include a special identifier (ID) (instead of a 5G-TMSI) that informs the UE that the AMF 202 has experienced an interruption in service. The first base station 206 can also transmit a paging record, where the paging record specifies which UE (e.g., UE 208) is being paged within an RRC paging message. The UE 208 can be configured during a registration as to which of the above techniques can be used to inform the UE 208 that the AMF 202 has experienced an interruption in service.

If the UE 208 is in idle mode, the notification can include, if the radio access network (RAN) node is a shared one, the first base station 206 can stop broadcasting the PLMN-ID of the PLMN. Additionally, the first base station 206 can include a bit in the SIB1 that indicates “disaster” or “the AMF 202 down”.

The first base station 206 can cease to broadcast a system information block type (SIB1) or synchronization signal block (SSB). This occurs in instances that the AMF 202 is the only AMF with which the first base station 206 is able to connect. The UE 208 can interpret the absence of the SIB1 or SSB as notification that the AMF 202 is experiencing an interruption of service.

The first base station 206 can also broadcast a new SIB, wherein the new SIB can inform the UE 208 that the AMF 202 has experienced an interruption in service.

The first base station 206 can also use a special type of ‘paging” message to inform the UE 208 that the AMF 202 has experienced an interruption in service. The first base station 206 can use a paging protocol to transmit a paging message that informs the UE 208 that the AMF 202 has experienced an interruption in service. For example, the first base station 206 can invoke a “global paging” to send message to all affected UEs (including UE 118). The first base station 110 can further include a special ID (instead of a 5G-TMSI) that informs the UE that the AMF 202 has experienced an interruption in service. The first base station 206 can also transmit a paging record, where the paging record specifies which UE (e.g., UE 208) is being paged within an RRC paging message. The UE 118 can be configured during a registration as to which of the above techniques can be used to inform the UE 118 that the AMF 202 has experienced an interruption in service.

The first base station 206 can inform the UE 208 that the AMF 202 has experienced an interruption in service by using a SysInfoModification indication, which is independent of any paging records. As an alternative, the UE 208 can transmit an RRC connection request, and the RAN can either reject the request or release the UE 208 from an RRC connection. To communicate the rejection, the first base station 206 can transmit a response including an RRC connection rejection or an RRC release to the UE 208. The first base station 206 can further include an indication that the CN is down.

At 216, the UE 208 can begin a registration process with a second base station 210 that is in the same PLMN as the first base station 206.

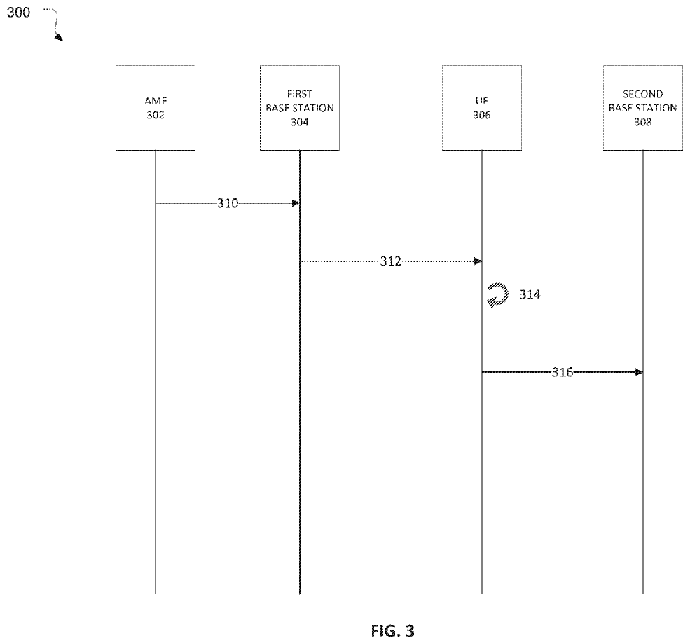

FIG. 3 is a signaling diagram for minimization of interruptions of core network failure, according to one or more embodiments. As illustrated an AMF 302 is in communication with a first base station 304, a UE 306, and a second base station 308. At 310, the AMF 302 can transmit a list to the first base station 304, the list can include at the TAs for which the AMF 302 is responsible.

At 312, the first base station 304 can retrieve the list of the TAs for which the first AMF 302 is responsible. The first base station 304 can further inform the UE 306 that the AMF 302 is experiencing a service interruption and reregister. The first base station 304 can further inform the UE 306 to not try to register in those TAs included in the list, even though they are under the same current R-PLMN.

At 314, the UE 306 can detect an acceptable/suitable cell and determine that the TAI of the cell indicates that the cell is not part of the list. In these instances, the UE 306 can ignore cell selection parameters (such as “hysteresis”) and camp on the detected cell. The UE 306 can further apply an offset to the “wait range” in the event that the CN has previously sent offset to the UE 306, for example, using a registration accept or a configuration update command.

At 316, the UE 306 can initiate registration in the same R-PLMN and transmit a registration request message to the second base station 308. The UE 316 can set the registration type set to mobility and periodic registration due to (previously registered) AMF 302 experiencing an interruption of service. Additionally, the registration request message can be sent with the UE identity set to a SUCI, even though it has a valid 5G-GUTI from the same PLMN.

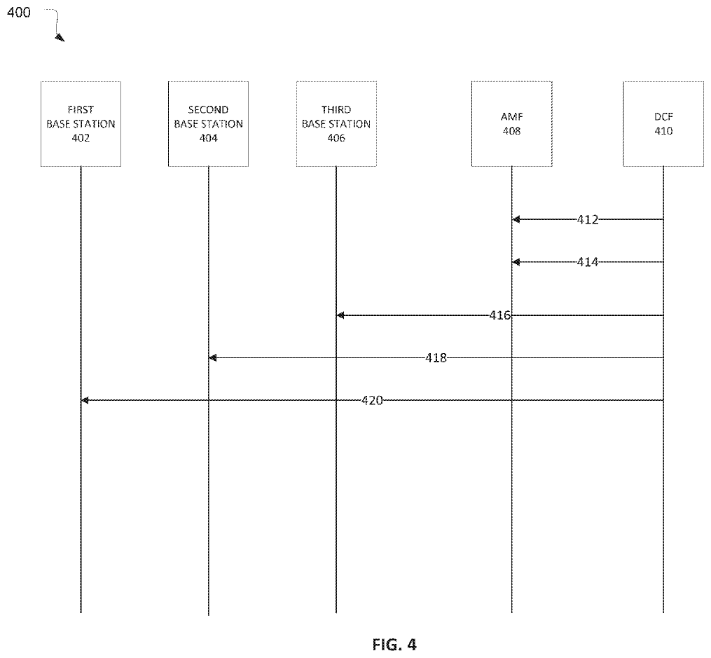

FIG. 4 is a signaling diagram for minimization of interruptions of core network failure, according to one or more embodiments. As illustrated, a first base station 402 can be in communication with a second base station 404, a third base station 406, an AMF 408, and a DCF 410. At 412, the AMF 408 can transmit a list of all base stations under its control to the DCF 410, where the AMF 408 and the DCF 410 are both nodes in a CN. The list can include the first base station 402, the second base station 404 and the third base station 406.

At 414, the AMF 408 can indicate to the DCF 410 that it is experiencing an interruption of service. The indication can be either a disaster alarm or the absence of a heartbeat response. In response, the DCF 410 can retrieve the list of base stations that the AMF 408 controls.

At 416, the DCF 410 can notify that third base station 406 that the AMF 408 is experiencing an interruption of service. At 418, the 410 can notify the second base station 404 that the AMF 408 is experiencing an interruption of service. At 420, the AMF 408 can notify the first base station 203 that the base station is experiencing an interruption of service.

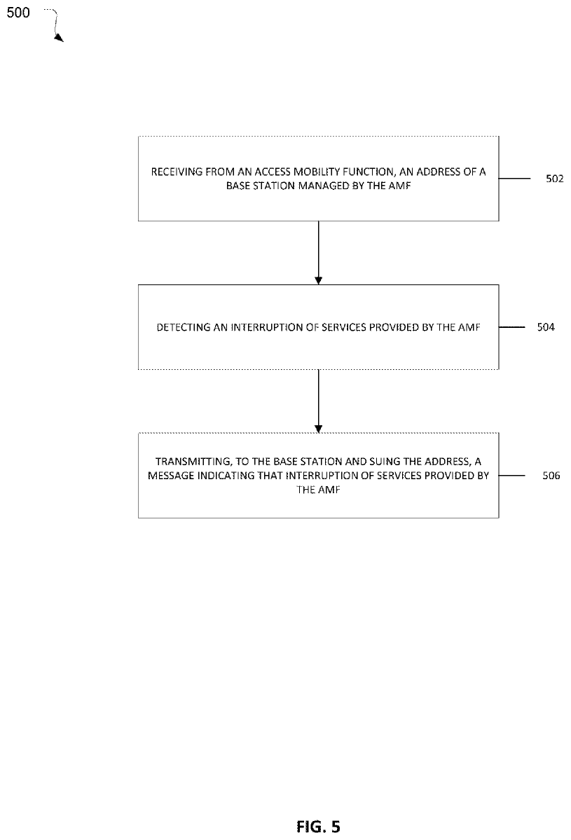

FIG. 5 is a process flow for minimization of interruptions of core network failure, according to one or more embodiments. At 502, the method can include a DCF of a CN receiving, from an AMF, an address of a base station managed by the AMF. The DCF can be in operable communication with the AMF via an interface and configured to provide assistance in the event that the AMF experiences an interruption of service.

At 504, the method can include the DCF detecting an interruption of services provided by the AMF. The detection can be based on a disaster alarm received from the AMF or the absence of a heartbeat from the AMF.

At 506, the method can include the DCF transmitting to the base station and using the address, a message indicating the interruption of services provided by the AMF.

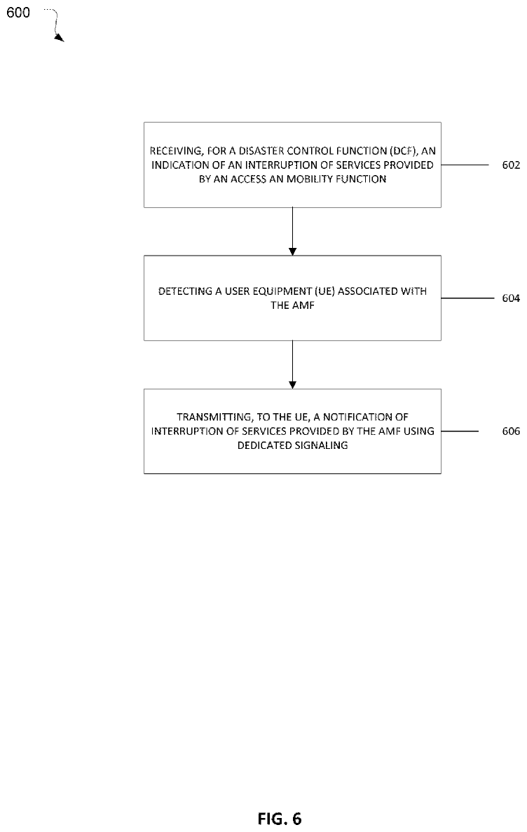

FIG. 6 is a process flow for minimization of interruptions of core network failure, according to one or more embodiments. At 602, the method can include a base station receiving, from a DCF, an indication of an interruption of services provided by an AMF.

At 604, the method can include the base station detecting a UE associated with the AMF. The base station can further detect whether the UE is in an idle mode or a connected mode.

At 606, the method can include the base station transmitting, to the UE, a notification of the interruption of services provided by the first AMF using dedicated signaling. The form of the notification can be based on whether the UE is in an idle mode or a connected mode.

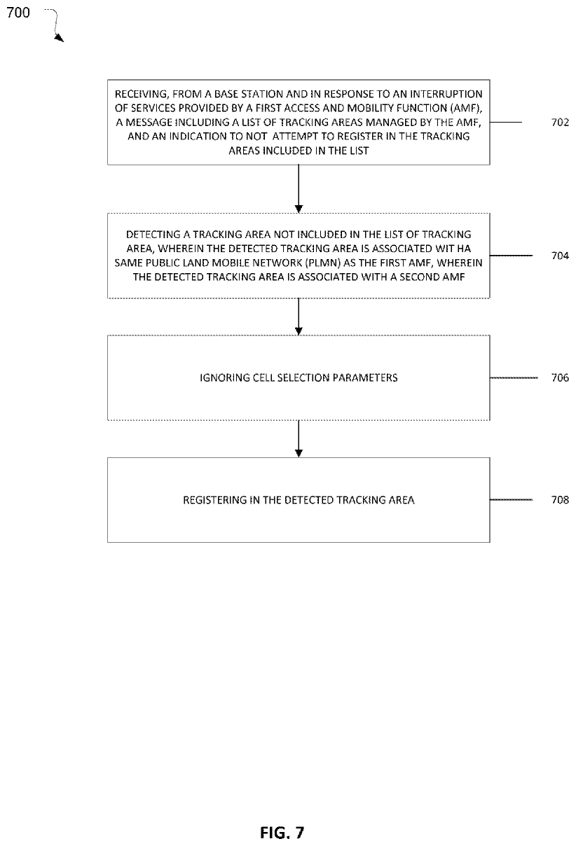

FIG. 7 is a process flow for minimization of interruptions of core network failure, according to one or more embodiments. At 702, the method can include UE receiving, from a base station and in response to an AMF having experienced a disaster, a message including a list of tracking areas managed by the AMF that experienced the disaster, and an indication to not attempt to register in the tracking areas included in the list.

At 704, the method can include the UE detecting a tracking area not included in the list of tracking areas, wherein the detected tracking area is associated with a same first public land mobile network (PLMN) as the first AMF that experienced the disaster, wherein the detected tracking area is associated with a second AMF.

At 706, the method can include the UE ignoring cell selection parameters.

At 708, the method can include the UE registering in the detected tracking area.

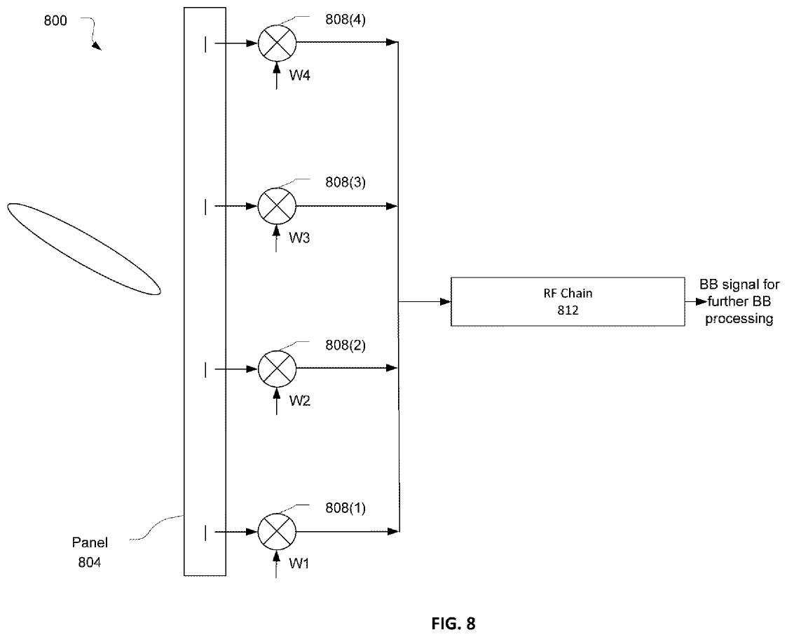

FIG. 8 illustrates receive components 800 of the UE, in accordance with some embodiments. The receive components 800 may include an antenna panel 804 that includes a number of antenna elements. The panel 804 is shown with four antenna elements, but other embodiments may include other numbers.

The antenna panel 804 may be coupled to analog beamforming (BF) components that include a number of phase shifters 808(1)-808(4). The phase shifters 808(1)-808(4) may be coupled with a radio-frequency (RF) chain 812. The RF chain 812 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (for example, W1-W4), which may represent phase shift values, to the phase shifters 808(1)-808(4) to provide a receive beam at the antenna panel 904. These BF weights may be determined based on the channel-based beamforming.

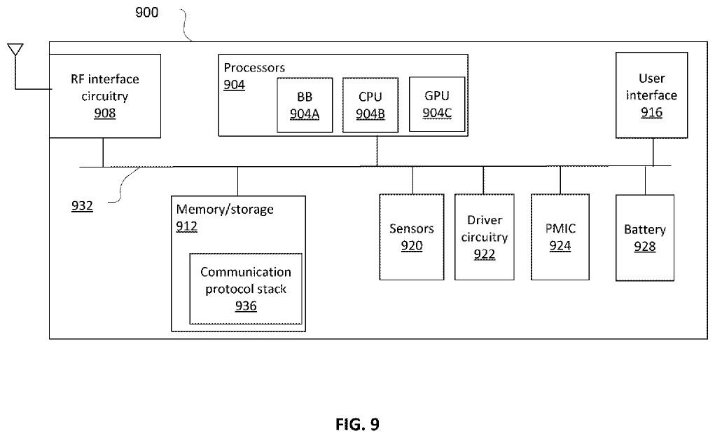

FIG. 9 illustrates a UE 900, in accordance with some embodiments. The UE 900 may be similar to and substantially interchangeable with UE of FIG. 1.

Similar to that described above with respect to UE, the UE 900 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 900 may include processors 904, RF interface circuitry 908, memory/storage 912, user interface 916, sensors 920, driver circuitry 922, power management integrated circuit (PMIC) 924, and battery 928. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangements of the components shown may occur in other implementations.

The components of the UE 900 may be coupled with various other components over one or more interconnects 932, which may represent any type of interface, input/output, bus (local, system, or expansion), transmission line, trace, optical connection, etc. that allows various circuit components (on common or different chips or chipsets) to interact with one another.

The processors 904 may include processor circuitry, such as, for example, baseband processor circuitry (BB) 904A, central processor unit circuitry (CPU) 904B, and graphics processor unit circuitry (GPU) 904C. The processors 904 may include any type of circuitry or processor circuitry that executes or otherwise operates computer-executable instructions, such as program code, software modules, or functional processes from memory/storage 912 to cause the UE 900 to perform operations as described herein.

In some embodiments, the baseband processor circuitry 904A may access a communication protocol stack 936 in the memory/storage 912 to communicate over a 3GPP compatible network. In general, the baseband processor circuitry 904A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 908.

The baseband processor circuitry 904A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 1104A may also access group information 924 from memory/storage 912 to determine search space groups in which a number of repetitions of a PDCCH may be transmitted.

The memory/storage 912 may include any type of volatile or non-volatile memory that may be distributed throughout the UE 900. In some embodiments, some of the memory/storage 912 may be located on the processors 904 themselves (for example, L1 and L2 cache), while other memory/storage 912 is external to the processors 904 but accessible thereto via a memory interface. The memory/storage 912 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 908 may include transceiver circuitry and a radio frequency front module (RFEM) that allows the UE 900 to communicate with other devices over a radio access network. The RF interface circuitry 908 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 924 and proceed to filter and amplify (with a low-noise amplifier) the signal. The signal may be provided to a receiver of the transceiver that down-converts the RF signal into a baseband signal that is provided to the baseband processor of the processors 904.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 924.

In various embodiments, the RF interface circuitry 908 may be configured to transmit/receive signals in a manner compatible with NR access technologies.

The antenna 924 may include a number of antenna elements that each convert electrical signals into radio waves to travel through the air and to convert received radio waves into electrical signals. The antenna elements may be arranged into one or more antenna panels. The antenna 924 may have antenna panels that are omnidirectional, directional, or a combination thereof to enable beamforming and multiple input, multiple output communications. The antenna 924 may include microstrip antennas, printed antennas fabricated on the surface of one or more printed circuit boards, patch antennas, phased array antennas, etc. The antenna 924 may have one or more panels designed for specific frequency bands, including bands in FR1 or FR2.

The user interface circuitry 916 includes various input/output (I/O) devices designed to enable user interaction with the UE 900. The user interface 916 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including inter alia, one or more simple visual outputs/indicators (for example, binary status indicators, such as light emitting diodes (LEDs) and multi-character visual outputs, or more complex outputs, such as display devices or touchscreens (for example, liquid crystal displays (LCDs), LED displays, quantum dot displays, projectors, etc.), with the output of characters, graphics, multimedia objects, and the like being generated or produced from the operation of the UE 900.

The sensors 920 may include devices, modules, or subsystems whose purpose is to detect events or changes in their environment and transmit the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 922 may include software and hardware elements that operate to control particular devices that are embedded in the UE 900, attached to the UE 900, or otherwise communicatively coupled with the UE 900. The driver circuitry 922 may include individual drivers allowing other components to interact with or control various input/output (I/O) devices that may be present within, or connected to, the UE 900. For example, driver circuitry 922 may include a display driver to control and allow access to a display device, a touchscreen driver to control and allow access to a touchscreen interface, sensor drivers to obtain sensor readings of sensor circuitry 920 and control and allow access to sensor circuitry 920, drivers to obtain actuator positions of electro-mechanic components or control and allow access to the electro-mechanic components, a camera driver to control and allow access to an embedded image capture device, audio drivers to control and allow access to one or more audio devices.

The PMIC 924 may manage power provided to various components of the UE 900. In particular, with respect to the processors 904, the PMIC 924 may control power-source selection, voltage scaling, battery charging, or DC-to-DC conversion.

In some embodiments, the PMIC 924 may control, or otherwise be part of, various power saving mechanisms of the UE 900. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 900 may power down for brief intervals of time and thus save power. If there is no data traffic activity for an extended period of time, then the UE 900 may transition off to an RRC_Idle state, where it disconnects from the network and does not perform operations, such as channel quality feedback, handover, etc. The UE 900 goes into a very low power state and it performs paging where again it periodically wakes up to listen to the network and then powers down again. The UE 900 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 928 may power the UE 900, although in some examples, the UE 900 may be mounted deployed in a fixed location, and may have a power supply coupled to an electrical grid. The battery 928 may be a lithium ion battery, a metal-air battery, such as a zinc-air battery, an aluminum-air battery, a lithium-air battery, and the like. In some implementations, such as in vehicle-based applications, the battery 928 may be a typical lead-acid automotive battery.

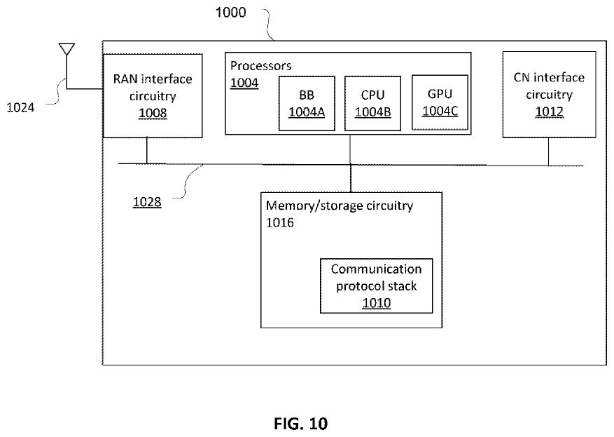

FIG. 10 illustrates a gNB 1000, in accordance with some embodiments. The gNB node 1000 may be similar to and substantially interchangeable with the base station 104 of FIG. 1.

The gNB 1000 may include processors 1004, RF interface circuitry 1008, core network (CN) interface circuitry 1012, and memory/storage circuitry 1016.

The components of the gNB 1000 may be coupled with various other components over one or more interconnects 1028.

The processors 1004, RF interface circuitry 1008, memory/storage circuitry 1016 (including communication protocol stack 1010), antenna 1024, and interconnects 1028 may be similar to like-named elements shown and described with respect to FIG. 8.

The CN interface circuitry 1012 may provide connectivity to a core network, for example, a 5^{th} Generation Core network (5GC) using a 5GC-compatible network interface protocol, such as carrier Ethernet protocols, or some other suitable protocol. Network connectivity may be provided to/from the gNB 1000 via a fiber optic or wireless backhaul. The CN interface circuitry 1012 may include one or more dedicated processors or FPGAs to communicate using one or more of the aforementioned protocols. In some implementations, the CN interface circuitry 1012 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes a method performed by a disaster control function (DCF) of a core network (CN), the method comprising: receiving, from an access and mobility function (AMF), an address of a base station managed by the AMF; detecting an interruption of services provided by the AMF; transmitting, to the base station and using the address, a message indicting the interruption of services provided by the AMF.

Example 2 includes the method of example 1, wherein detecting the interruption of services including: determining a heartbeat signal from the AMF is not received by the DCF; or receiving an alarm from the AMF.

Example 3 includes a device, including: a processor; and a computer-readable medium including instructions that, when executed by the processor, cause the processor to perform the operations of any of examples 1 and 2.

Example 4 includes a non-transitory computer-readable medium including stored thereon a sequence of instructions that, when executed by a processor of a cloud infrastructure node, causes the processor to perform operations of any of examples 1 and 2.

Example 5 includes a method performed by a base station, the method including: receiving, from a disaster control function (DCF), an indication of an interruption of services provided by an access and mobility function (AMF); detecting a user equipment (UE) associated with the AMF; transmitting, to the UE, a notification of the interruption of services provided by the first AMF using dedicated signaling.

Example 6 includes the method of example 5, wherein the UE is in a connected mode, and wherein the dedicated signaling is a radio resource control (RRC) release message and the notification is a cause code or an information element (IE).

Example 7 includes the method of example 5, wherein the UE is in a connected mode, the notification is a first notification, the AMF is a first AMF, and the method further includes: transmitting a second notification that a second AMF is available; or transmitting a second notification to the UE to initiate a minimization of service interruption (MINT) protocol with a first service provider different than a second service provider that manages the first AMF.

Example 8 includes the method of example 5, wherein the UE is in a connected mode; the base station is not associated with any AMFs other than the AMF; and the base station ceases broadcasting of system information block #1 (SIB1) or a synchronization signal block (SSB).

Example 9 includes the method of example 5, wherein the UE is in a connected mode, and the notification is transmitted to the UE using downlink control information (DCI).

Example 11 includes the method of example 5, wherein the UE is in a connected mode and the notification is a paging message or a paging record.

Example 12 includes the method of any of examples 5 and 10, wherein the notification is a paging message that includes a special identifier and does not include a fifth generation temporary mobile subscriber identity (5G-TMSI).

Example 13 includes the method of example 5, wherein the UE is in an idle mode; a radio access network (RAN) node associated with the base station is a shared node; and the notification includes broadcasting a system information block 1 (SIB1) without a public land mobile network identifier (PLMN-ID) associated with the AMF.

Example 14 includes the method of example 5, wherein the UE is in an idle mode and the base station ceases broadcasting of system information block #1 (SIB1) or a synchronization signal block (SSB).

Example 15 includes the method of example 5, wherein the UE is in an idle mode, the indication is a first indication, and the method further includes receiving, from the UE, a second indication that the UE supports global paging for AMF service interruptions, wherein the second indication is received using radio resource control (RRC) setup request message, an RRC setup complete message, or a UE capability message, and wherein the notification is a paging message or paging record.

Example 16 includes the method of example 5, wherein the indication is a paging message that includes a special identifier, and wherein the special identifier is included instead of a fifth generation temporary mobile subscriber identity (5G-TMSI).

Example 17 includes the method of example 5, wherein the UE is in the idle mode, and wherein the indication that the AMF has experienced a disaster is sent through a system information modification report.

Example 18 includes the method of example 5, wherein the method further includes: receiving, from the UE, an RRC connection request; and transmitting, to the UE an RRC connection rejection or an RRC connection release and an indication that a core network (CN) is down.

Example 19 includes a device, including: a processor; and a computer-readable medium including instructions that, when executed by the processor, cause the processor to perform the operations of any of examples 3-18.

Example 20 includes a non-transitory computer-readable medium including stored thereon a sequence of instructions that, when executed by a processor of a cloud infrastructure node, causes the processor to perform operations of any of examples 3-18.

Example 21 includes a method including: receiving, from a base station and in response to a first access and mobility function (AMF) having experienced a disaster, a message including a list of tracking areas managed by the first AMF that experienced the disaster, and an indication to not attempt to register in the tracking areas included in the list; detecting a tracking area not included in the list of tracking areas, wherein the detected tracking area is associated with a same public land mobile network (PLMN) as the first AMF that experienced the disaster, wherein the detected tracking area is associated with a second AMF; ignoring cell selection parameters; and registering in the detected tracking area.

Example 22 includes the method of example 21, wherein the PLMN is a first PLMN, wherein the UE has previously received an offset to a wait range for registering with a second PLMN, the method further includes applying the offset for registering in the detected tracking area associated with the first PLMN.

Example 23 includes the method of any of examples 21 and 21, wherein registering in the detected tracking area includes transmitting a registration request message, wherein the registration message includes a registration type set to mobility and periodic registration.

Example 24 includes the method of any of examples 21-23, wherein registering in the detected tracking area includes transmitting a registration request message, wherein the registration message includes a UE identity set to a subscription concealed identifier (SUCI).

Example 25 includes the method of any of examples 21-24, wherein the base station received the list of tracking areas from the AMF that experienced the disaster.

Example 26 includes a non-transitory computer-readable medium including stored thereon a sequence of instructions that, when executed by a processor of a cloud infrastructure node, causes the processor to perform operations of any of examples 21-25.

Example 27 includes a device, including: a processor; and a computer-readable medium including instructions that, when executed by the processor, cause the processor to perform the operations of any of examples 21-25.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1-20. (canceled)

21. A method comprising:
receiving, from an access and mobility function (AMF), an address of a base station managed by the AMF;
detecting an interruption of services provided by the AMF; and
generating a message for transmission to the base station using the address, the message to indicate the interruption of services provided by the AMF.

22. The method of claim 21, wherein detecting the interruption of services comprises determining that a heartbeat signal from the AMF is not received by a disaster control function (DCF), or receiving an alarm from the AMF.

23. An apparatus comprising:
processor circuitry to:
receive, from a disaster control function (DCF), an indication of an interruption of services provided by an access and mobility function (AMF);
detect a user equipment (UE) associated with the AMF; and
cause transmission of a notification to the UE of the interruption of services provided by the AMF using dedicated signaling; and
interface circuitry coupled to the processor circuitry to enable communication.

24. The apparatus of claim 23, the processor circuitry further to:
determine that the UE is in a connected mode, wherein the dedicated signaling is a radio resource control (RRC) release message, and wherein the notification is a cause code or an information element (IE).

25. The apparatus of claim 23, wherein the notification is a first notification, wherein the AMF is a first AMF, and wherein the processor circuitry further to:
determine that the UE is in a connected mode; and
transmit a second notification that a second AMF is available based on determining that the UE is in a connected mode.

26. The apparatus of claim 23, wherein the notification is a first notification, wherein the AMF is a first AMF, and wherein the processor circuitry further to:
determine that the UE is in a connected mode; and
transmit a second notification to the UE to initiate a minimization of service interruption (MINT) protocol with a first service provider different than a second service provider that manages the first AMF based on determining that the UE is in connected mode.

27. The apparatus of claim 23, wherein the apparatus is not associated with any AMFs other than the AMF, and wherein the processor circuitry further to:
determine that the UE is in a connected mode; and
cause broadcasting of system information block #1 (SIB1) or a synchronization signal block (SSB) to cease based on determining that the UE is in the connected mode.

28. The apparatus of claim 23, the processor circuitry further to:
determine that the UE is in a connected mode, wherein the notification is transmitted to the UE using downlink control information (DCI) based on determining that the UE is in the connected mode.

29. The apparatus of claim 23, wherein the notification is a paging message that includes a special identifier and does not include a Fifth generation (5G) temporary mobile subscriber identity (TMSI).

30. The apparatus of claim 23, wherein a radio access network (RAN) node associated with the apparatus is a shared node, and wherein the processor circuitry further to:
determine that the UE is in idle mode, and wherein the notification includes broadcasting a system information block 1 (SIB1) without a public land mobile network identifier (PLMN-ID) associated with the AMF based on determining that the UE is in the idle mode.

31. The apparatus of claim 23, the processor circuitry further to:
determine that the UE is in an idle mode; and
cause broadcasting of system information block #1 (SIB1) or a synchronization signal block (SSB) to cease based on determining that the UE is in the idle mode.

32. The apparatus of claim 23, wherein the indication is a first indication, and wherein the processor circuitry further to:
determine that the UE is in an idle mode; and
receive, from the UE, a second indication that the UE supports global paging for AMF service interruptions, wherein the second indication is received using radio resource control (RRC) setup request message, an RRC setup complete message, or a UE capability message, and wherein the notification is a paging message or paging record.

33. The apparatus of claim 32, wherein the indication is a paging message that includes a special identifier, and wherein the special identifier is included instead of a Fifth generation (5G) temporary mobile subscriber identity (TMSI).

34. The apparatus of claim 23, the processor circuitry further to:
determine that the UE is in an idle mode, wherein the indication that the AMF has experienced a disaster is sent through a system information modification report based on determining that the UE is in the idle mode.

35. The apparatus of claim 23, the processor circuitry further to:
receive an RRC connection request; and
transmit an RRC connection rejection or an RRC connection release based on receiving the RRC connection request; and
transmit an indication that a core network (CN) is down.

36. One or more non-transitory, computer-readable media comprising a sequence of instructions that, when executed, causes processor circuitry to:
process a message received from a base station and in response to a first access and mobility function (AMF) having experienced a disaster, the message including a list of tracking areas managed by the first AMF that experienced the disaster, and an indication to not attempt to register in the tracking areas included in the list;
detect a tracking area not included in the list of tracking areas, wherein the detected tracking area is associated with a same public land mobile network (PLMN) as the first AMF that experienced the disaster, wherein the detected tracking area is associated with a second AMF;
ignore cell selection parameters; and
register in the detected tracking area.

37. The one or more non-transitory, computer-readable media of claim 36, wherein the PLMN is a first PLMN, wherein the processor circuitry has previously received an offset to a wait range for registering with a second PLMN, and wherein the sequence of instructions that, when executed, further causes the processor circuitry to
apply the offset for registering in the detected tracking area associated with the first PLMN.

38. The one or more non-transitory, computer-readable media of claim 36, wherein registering in the detected tracking area includes transmitting a registration request message, and wherein the registration message includes a registration type set to mobility and periodic registration.

39. The one or more non-transitory, computer-readable media of claim 36, wherein registering in the detected tracking area includes transmitting a registration request message, and wherein the registration message includes a UE identity set to a subscription concealed identifier (SUCI).

40. The one or more non-transitory, computer-readable media of claim 36, wherein the base station processed the list of tracking areas from the AMF that experienced the disaster.
